(19) United States
(12) Patent Application Publication
(10) Pub. No.: US 2004/0182194 A1
(43) Pub. Date: Sep. 23, 2004

(54) Handlebar stem

(76) Inventor: Cheng-Hsun Chiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/389,996

(22) Filed: Mar. 18, 2003

(51) Int. Cl. B62K 21/12

(52) U.S. Cl. 74/551.8

(57) ABSTRACT

A handlebar stem includes a stem and a first connection member has a first hole defined therein so that a first end of the stem is inserted in the first hole. A first passage is defined through the first connection member so as to receive a steerer tube. A second connection member has a second hole and a second end of the stem is inserted in the second hole. A second passage is defined through the second connection member so as to be connected to a handlebar. The second end of the stem is inserted in the second hole of the second connection member. The shape of the stem can be made according to needs and the first connection member and the second connection member do not need to have long insertions.

### FIELD OF THE INVENTION

The present invention relates to a handlebar stem which includes two connection members respectively mounted to two ends of the stem by adhesive so as to reduce the weight of the combination.

### BACKGROUND OF THE INVENTION

A conventional handlebar stem for bicycles is shown in FIGS. 10 and 11 and generally includes a stem 12 which has a first open end and a second open end. A first connection member 11 has an insertion 14 which is inserted in the first open end of the stem 12 and the insertion 14 is glued so as to be fixed to the stem 12. The first connection member 11 is fixedly connected to a steerer tube which is not shown. A second connection member 13 has an insertion 130 which is inserted in the second open end of the stem 12 and the insertion 130 is glued so as to be fixed to the stem 12. The second connection member 13 is connected to a handlebar which is not shown.

In order to secure the connection of the first connection member 11, the second connection member 13 and the stem 12, the insertions 14, 130 are made long so as to have larger adhesive area. Nevertheless, this makes the whole combination to be overweight. Furthermore, the fiber or compound material made stem 12 can only be made to have a circular cross section so that the outer appearance of the stem 12 cannot be satisfied by the customers.

The present invention intends to provide a handlebar stem that is inserted into two connection members and can be made to be various shapes.

### SUMMARY OF THE INVENTION

In accordance with one aspect of the present invention, there is provided a handlebar stem which comprises a stem and a first connection member is connected to a first end of the stem by inserting the first end of the stem in a first hole of the first connection member. A first passage is defined through the first connection member so as to receive a steerer tube. A second connection member has a second hole and a second passage is defined through the second connection member so as to receive a handlebar. The second end of the stem is inserted in the second hole of the second connection member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the handlebar stem of the present invention;

FIG. 2 is a cross sectional view to show the handlebar stem of the present invention;

FIG. 3 is a perspective view to show the handlebar stem of the present invention;

FIG. 4 is a cross sectional view to show another embodiment of the handlebar stem of the present invention, wherein a through hole is not yet drilled;

FIG. 5 is a cross sectional view to show the handlebar stem in FIG. 4, wherein the through hole is drilled;

FIG. 6 shows the through hole in the stem of the present invention;

FIG. 7 is a cross sectional view to show yet another embodiment of the handlebar stem of the present invention, wherein a through hole is not yet drilled;

FIG. 8 is a cross sectional view to show the handlebar stem in FIG. 7, wherein the through hole is drilled;

FIG. 9 shows the through hole in the stem of the embodiment in FIG. 7 of the present invention;

FIG. 10 is an exploded view to show a conventional handlebar stem, and

FIG. 11 is a cross sectional view to show the conventional handlebar stem.

### DETAILED DESCRIPTION OF THE PREFERRED EMBODIMENTS

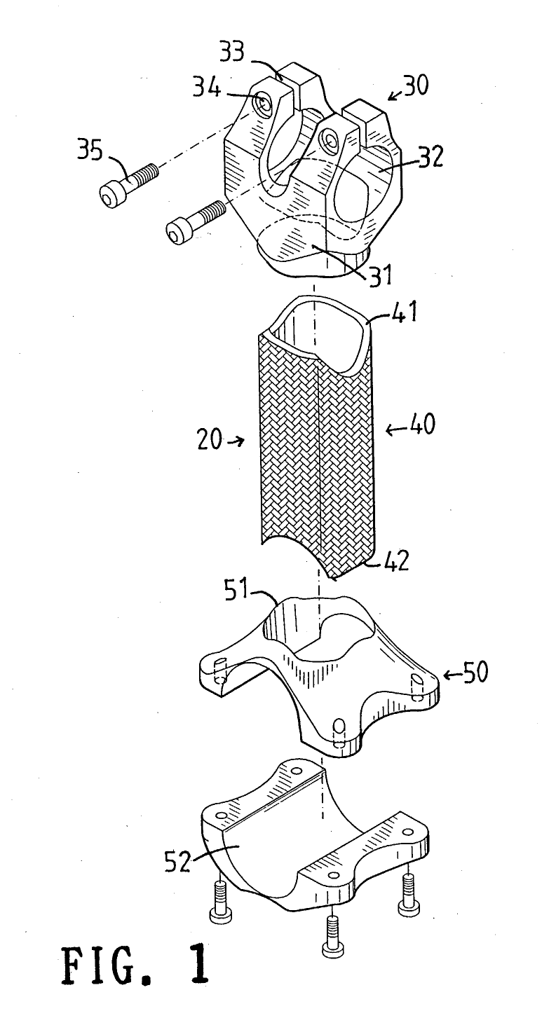

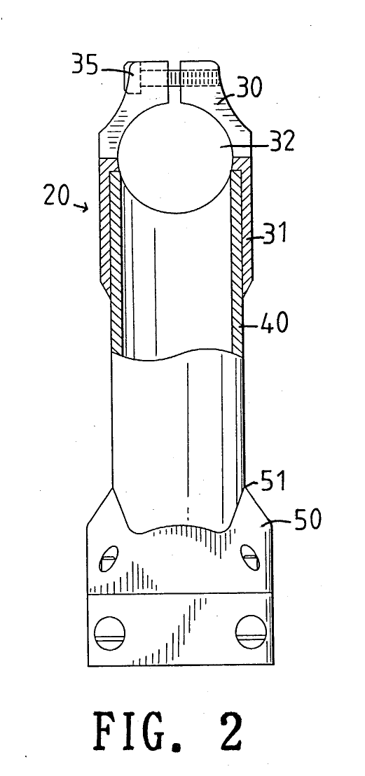

Referring to FIGS. 1 to 3, the handlebar stem 20 of the present invention comprises a stem 40 having a first end 41 and a second end 42. A first connection member 30 has a first hole 31 defined in an underside thereof and two C-shaped lugs extend from a top of the first connection member 30. A first passage 32 is defined through the two C-shaped lugs and each lug includes two distal ends between which a gap 33 is defined. The C-shaped lugs are fastened by extending a bolt 35 through a hole 34 defined in one of the two distal ends and threadedly engaged with the other distal end. By this way, the steerer tube can be securely connected to the first connection member 30. The first end 41 of the stem 40 is glued with adhesive and inserted in the first hole 31 of the first connection member 30.

A second connection member 50 is composed of two parts which are connected with each other by bolts. A second hole 51 is defined in one of the parts and a second passage 52 is defined between the two parts so as to receive a handlebar which is not shown. The second end 42 of the stem 40 is glued with adhesive and inserted in the second hole 51 of the second connection member 50.

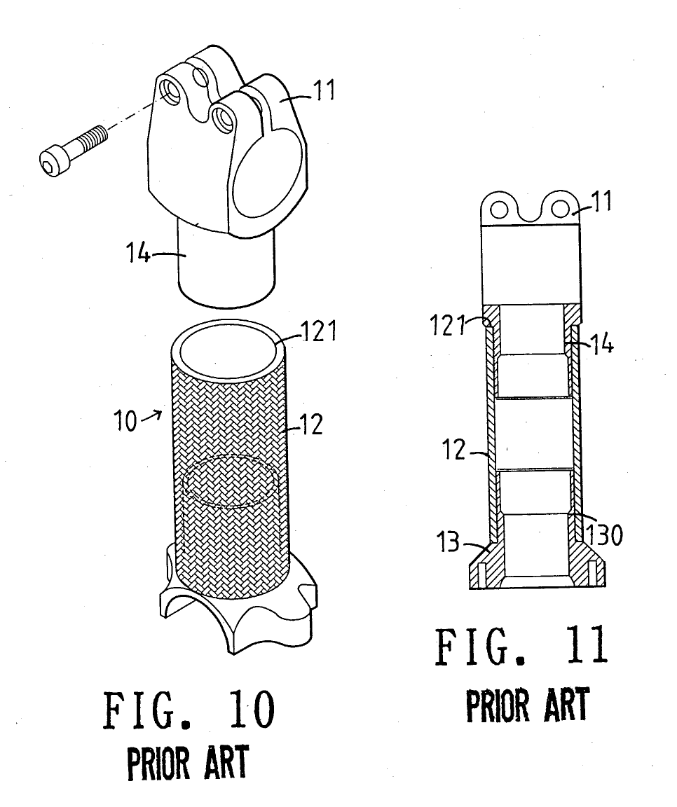

The first connection member 30 and the second connection member 50 need not to have a long insertion as described in FIGS. 10 and 11 so that the total weight can be reduced. Besides, the stem 40 can be made by fiber or compound material and may be displayed as various shapes as needed.

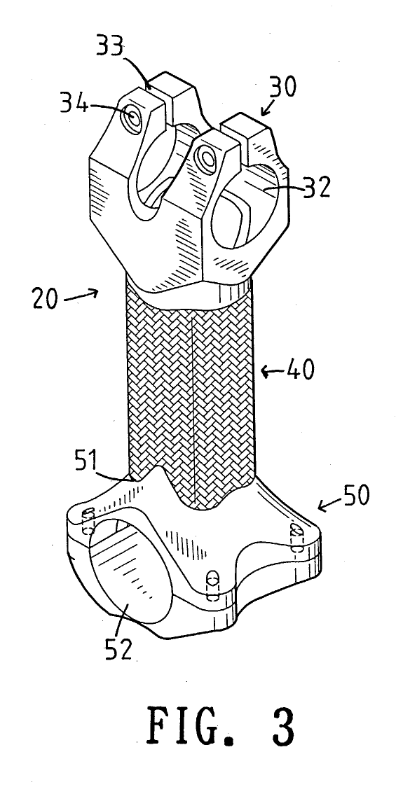

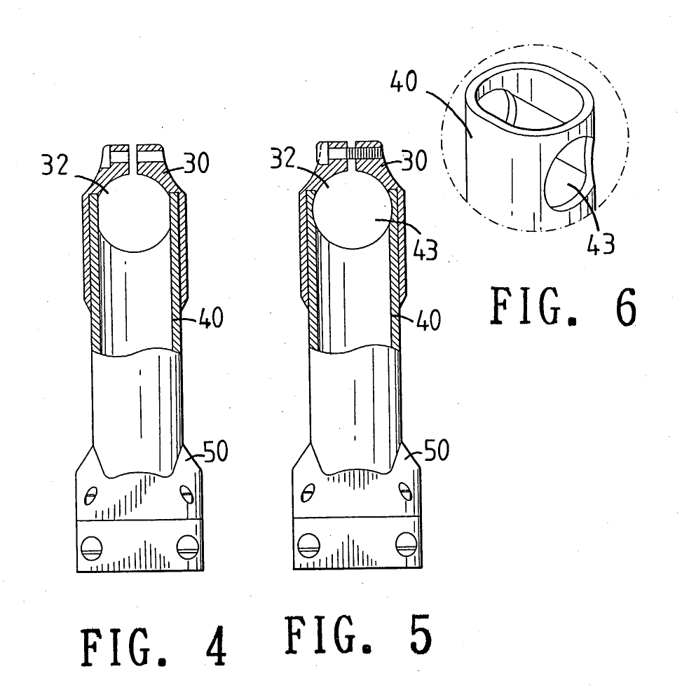

Referring to FIGS. 4 to 6, the first end 41 of the stem 40 may include a through hole 43 which is located in alignment with the first passage 32. By this arrangement, the steerer tube may extend through the through hole 43 so that the connection between the steerer tube and the handlebar stem 40 is more secured.

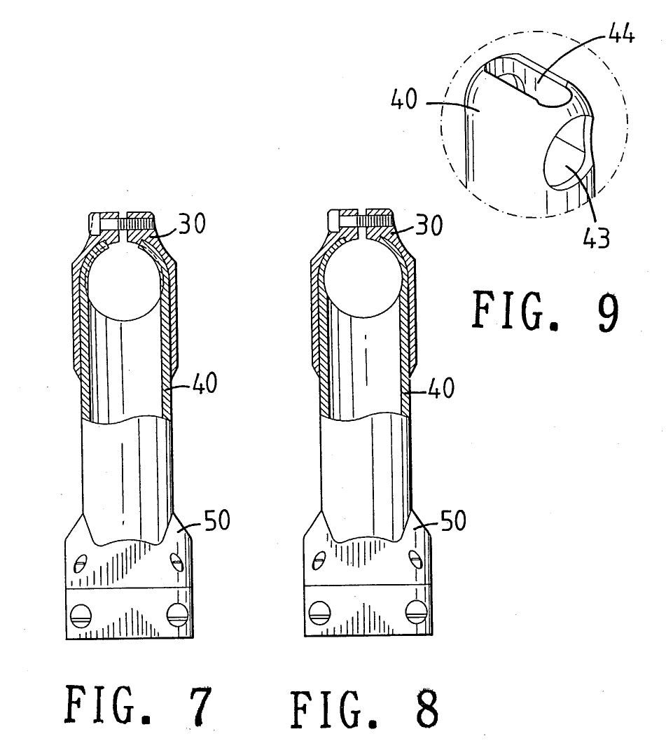

Referring to FIGS. 7 to 9, the first end of the stem 40 with the through hole 43 can also be a rounded end and a top hole 44 is defined through the rounded end.

While we have shown and described the embodiment in accordance with the present invention, it should be clear to those skilled in the art that further embodiments may be made without departing from the scope of the present invention.

What is claimed is:

1. A handlebar stem comprising:
a stem having a first end and a second end;
a first connection member having a first hole defined therein and a first passage defined through the first connection member so as to be adapted to receive a steerer tube, the first end of the stem inserted in the first hole of the first connection member, and
a second connection member having a second hole and a second passage defined through the second connection member so as to be adapted to receive a handlebar, the second end of the stem inserted in the second hole of the second connection member.

2. The handlebar stem as claimed in claim 1, wherein the first connection member includes two C-shaped lugs and the first passage is defined through the two C-shaped lugs.

3. The handlebar stem as claimed in claim 2, wherein each C-shaped lug is fastened by extending a bolt through two distal ends thereof.

4. The handlebar stem as claimed in claim 1, wherein the first end of the stem includes a through hole which is located in alignment with the first passage.

5. The handlebar stem as claimed in claim 4, wherein the first end of the stem is a rounded end and a top hole is defined through the rounded end.
